(19) United States
(12) Patent Application Publication
(10) Pub. No.: US 2001/0038511 A1
(43) Pub. Date: Nov. 8, 2001

(54) Magnetic head having a magnet core comprising two core elements and a rear terminating element connected by a non-connecting layer

(76) Inventors: Josef Summer, Neunkirchen (AT); Karl Kocisek, Haslau a.d. Donau (AT); Ulrich Traxlmayr, Laxenburg (AT)

Correspondence Address: Jack E. Haken, U.S, Philips Corporation, 580 White Plains Road, Tarrytown, NY, 10591, US

(21) Appl. No.: 09/814,389

(22) Filed: Mar. 21, 2001

(30) Foreign Application Priority Data
Mar. 21, 2000 (EP) 00890087.0

(51) Int. Cl. G11B 5/127

(52) U.S. Cl. 360/125

(57) ABSTRACT

In a magnetic head (1) having a ring-like magnetic core (4) consisting of two core elements (9, 10) and having a terminating element (21) connected to the two core elements (9, 10) at the rear of the core elements (9, 10) by means of a connecting layer (23), the two core elements (9, 10) have a constant thickness and are without material recesses in their rear portion (8) and the connecting layer (23) between the two core elements (9,10) and the terminating element (21) consists of a layer having a high magnetic resistance, preferably of a non-magnetic material such as solder glass.

The invention relates to a magnetic head as defined in the opening part of claim 1.

Such a magnetic head is known from the Abstract of the patent document JP 4-113-503-A. In the known magnetic head the magnetic core has two channel-like recesses which extend parallel to the two lateral portions of the magnetic core and are filled with a non-magnetic filling material and which extend wholly through both the front portion and the rear portion of the magnetic core and partly through a lateral portion. The two channel-like recesses serve to bound the dimension of the effective magnetic gap of the magnetic core or, as the case may be, the magnetic head, in a direction transverse to the two plane main bounding surfaces. Since the two channel-like recesses also extend wholly through the rear portion of the known magnetic head, a narrow part is formed in this rear portion, which narrow part lies between the two channel-like recesses. This narrow part gives rise to an undesirably high magnetic resistance in the rear portion of the magnetic core, which has an unfavorable influence on the results that can be obtained by means of the known magnetic head. In order to reduce this unfavorable influence of the narrow part the known magnetic head is provided with a terminating element of a soft-magnetic material having a high permeability. In the known magnetic head the width dimension of the rear portion of the magnetic core, which portion extends parallel to the two plane main bounding surfaces, is comparatively small, but this does not cause any problems as regards a good mechanical stability because the terminating element is connected to the magnetic core in the rear area of this core. The connection of the terminating portion to the two core elements in the known magnetic head is realized with the aid of a connecting layer whose magnetic resistance is as small as possible in order to achieve that the desired effect of the terminating element, which consists of a soft-magnetic material having a high permeability, is affected to the least possible extent.

In the present context reference is also made to a known magnetic head disclosed in the patent document U.S. Pat. No. 4,905,111 A. This known magnetic head also has a ring-like like magnetic core which is formed by means of core elements ans which has a front portion and two lateral portions as well as a rear portion. The magnetic head is designed in such a manner that in its two lateral portions and in its rear portion the magnetic core has a thickness which is constant throughout and which is defined by the distance between the two plane main bounding surfaces, as a result of which the magnetic head known from the patent document U.S. Pat. No. 4,905,111 A, in contradistinction to the magnetic head known from the patent document JP 4-113-503-A, does not have a narrow part in its rear portion, owing to which the known magnetic head does not have an undesirably high magnetic resistance in the rear portion of the magnetic core. In the magnetic head known from the patent document U.S. Pat. No. 4,905,111 A the dimension of the rear portion in a direction parallel to the two plane main bounding surfaces, i.e. the width of the rear portion, is comparatively large, as a result of which a good mechanical stability is obtained but which is unfavorable in view of a minimal sensitivity to noise and a minimal susceptibility to external stray fields.

It is an object of the invention to provide an improved magnetic head whose magnetic core does not have a narrow part in its rear portion and which has a minimal sensitivity to noise and a minimal susceptibility to external stray fields.

According to the invention, in order to each the afore-mentioned object, the characteristic features defined in the characterizing part of claim 1 are provided, in addition, in a magnetic head as defined in the opening part of claim 1.

The construction of a magnetic head in accordance with the invention guarantees a high mechanical stability of the magnetic head and, in particular, a high mechanical stability of the magnetic head in the area of its back and results in a smaller magnetic resistance in the rear portion of the magnetic core of the magnetic head, while in addition the provision of a connecting layer having a high magnetic resistance between the two core elements of the magnetic core and the terminating element has the advantage that the magnetic head in accordance with the invention has a distinctly smaller sensitivity to noise and a distinctly smaller susceptibility to external stray fields than the known magnetic heads. A further advantage of the magnetic head in accordance with the invention is that this magnetic head can be manufactured more cheaply than the known magnetic heads. A further advantage of the known magnetic head is that the terminating element can be given almost arbitrarily large dimensions, of course within reasonable limits, as a result of which the terminating portion can also be used as a fixing means for securing the magnetic head, for example to secure it to a so-called head disc, which enables a separate fixing element, such as a so-called head-mounting plate of brass, to be dispensed with.

In a magnetic head in accordance with the invention the terminating element may consist of a magnetic polycrystalline ferrite. However, in a magnetic head in accordance with the invention it has proved to be very advantageous when the terminating element consists of a non- magnetic polycrystalline ferrite. This material has the advantage that it is machinable in a very simple manner but, above all, that in this case the terminating element does not exert any magnetic influence at all on the magnetic core.

However, in a magnetic head in accordance with the invention it is also advantageous if the terminating element consists of a ceramic material or of glass.

For a magnetic head in accordance with the invention it has proved to be particularly advantageous if, in addition, the characteristic feature defined in claim 5 is provided. In practice, a layer thickness in the range of 10.0 μm guarantees a satisfactorily high magnetic resistance. In addition, it has also proved to be particularly advantageous when the connecting layer consists of solder glass because this provides a connection having a high mechanical stability.

The above-mentioned as well as further aspects of the invention will become apparent from the embodiment described hereinafter by way of example and will be elucidated with reference to this example.

The invention will now be described in more detail with reference to the drawing, which shows an embodiment given by way of example but to which the invention is not limited.

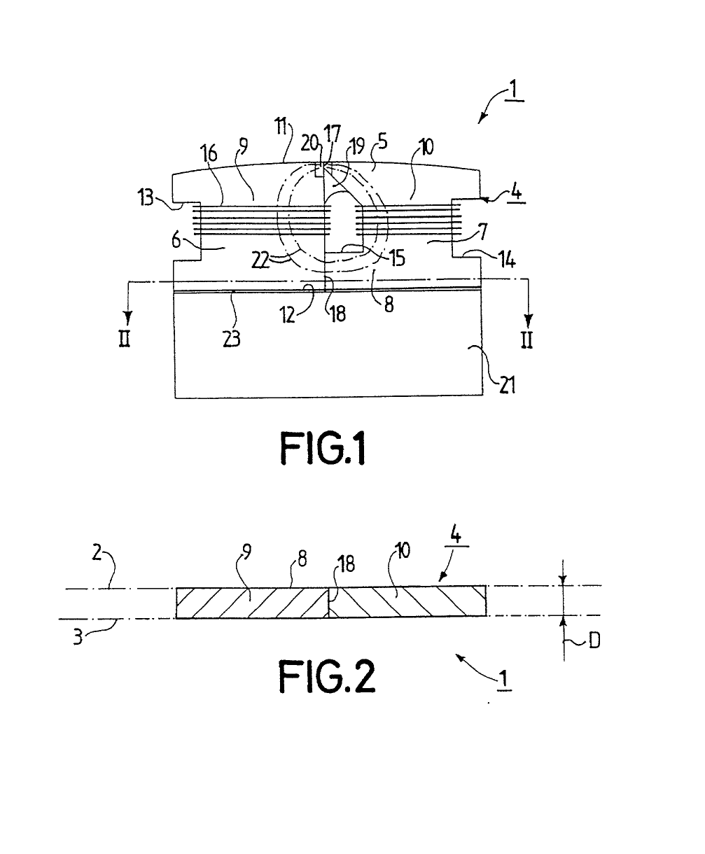

FIG. 1 shows a magnetic head in accordance with an embodiment of the invention in a plan view and to a scale which is enlarged several times.

FIG. 2 shows the magnetic head shown in FIG. 1 in a sectional view taken on the line II-II in FIG. 1.

FIGS. 1 and 2 show a magnetic head 1 which is bounded by two plane main bounding surfaces 2 and 3 which extend parallel to one another and which are each represented as a dash-dot line. The magnetic head 1 has a magnetic core 4 disposed between the two plane main bounding surfaces 2 and 3, which core is substantially ring-shaped and is therefore often also referred to as a magnetic ring core. The ring-like magnetic core 4 has a front portion 5 and two lateral portions 6 and 7, as well as a rear portion 8. The magnetic core 4 is formed by means of two core elements 9 and 10, which extend parallel to the plane main bounding surfaces 2 and 3 and which adjoin one another. In the present case, the two core elements 9 and 10 consists of a monocrystalline ferrite. The two core elements 9 and 10 are bounded, on the one hand, by a front bounding surface 11 which extends perpendicularly to the plane main bounding surfaces 2 and 3 and which has a substantially circularly arcuate shape, and, on the other hand, by a plane rear bounding surface 12 which extends perpendicularly to the plane main bounding surfaces 2 and 3.

In each of its two lateral portions 6 and 7 the magnetic core 4 has a recess 13 or 14, respectively. The magnetic core 4 has a so-called coil window 15 in the area of the second core element 10. The two recesses 13 and 14 and the coil window 15 serve to accommodate a head winding 16, which is shown only diagrammatically in FIG. 1. The first core element 9 and the second core element 10 form an effective front air gap 17 and a rear air gap 18 in their end portions in which the two core elements 9 and 10 adjoin one another. Adjacent the effective front air gap 17 the coil window 18 has a filling 19, which consists of a non-magnetic material, in the present case glass, and which serves to improve the mechanical stability of the magnetic head 1 and its magnetic core 4 in the area of the effective air gap 17.

In its two lateral portions 6 and 7 and in its rear portion 8 the magnetic core 4 advantageously has a thickness D which is constant throughout and which is defined by the distance D between the two plane main bounding surfaces 2 and 3. As a result of this, undesirable influences on a minimal magnetic resistance in this rear portion 8 and in the two lateral portions 6 and 7 are avoided. In the present case, the thickness D is approximately 200 μm, but it may also be just 150 μm. The magnetic core 4 has material recesses 20 formed by laser-machining in the area of the effective air gap 17. The material recesses 20 define the dimension of the effective air gap 17 in a direction transverse to the plane main bounding surfaces 2 and 3, which dimension is 50 μm in the present case. Smaller values between 20 μm and 50 μm are also possible.

The magnetic head 1 has a terminating element 21 arranged at the rear and having a block shape, which element is connected to the two core elements 9 and 10 in the area of the plane rear bounding surface 12 of the magnetic core 4. The connection between the two core elements 9 and 10 and the terminating element 21 is made by means of a connecting layer 23 which has a high magnetic resistance and, in the present case, consists of a non-magnetic material. The connecting layer 23 is formed by a layer of solder glass. The layer thickness of the connecting layer 23 is in the range of around 10 μm. However, the connecting layer 23 may alternatively consist of an adhesive layer.

In the magnetic head 1 the terminating element 21 advantageously consists of a non-magnetic material. In the present case, the terminating element 21 consists of a nonmagnetic polycrystalline ferrite. In the magnetic head 1 the terminating element 21 has substantially no undesirable influence on the useful magnetic field 22 shown in dash-dot lines in FIG. 1, because this useful magnetic field 22 extends mainly around the coil window 15. The provision of the terminating element 21 of a non-magnetic material in the magnetic head 1 has major advantages because the magnetic head 1 is less sensitive to noise and is also less susceptible to stray fields in comparison with known magnetic heads. A further advantage of the magnetic head 1 is that the cost price of this magnetic head is smaller than the cost price of known magnetic heads, which is mainly attributable to the fact that the terminating element 21 consists of a comparatively cheap material, i.e. in comparison with the material of which the two core elements 9 and 10 of the magnetic head 1 are made.

In modifications of the magnetic head 1 as shown in FIGS. 1 and 2 the terminating element 21 may alternatively consist of a ceramic material or of a glass material. In a further modification of the magnetic head 1 as shown in FIGS. 1 and 2 the terminating element 21 may consist of a magnetic polycrystalline ferrite which, although it exhibits a magnetic behavior, it can exert hardly any undesired influence on the useful magnetic field 22 in the magnetic core 4 because of the non-magnetic connecting layer 23 between the terminating element 21 and the two core elements 9 and 10 of the magnetic core 4. Finally, it is to be noted that the inventive measures may also be applied to magnetic heads whose magnetic cores do not consist of two integral monocrystalline ferrite core elements but whose magnetic cores have a construction referred to as the “metal-in-gap” construction or as the “laminated” construction.

1. A magnetic head (1)
which is bounded by two main bounding surfaces (2, 3) which extend parallel to one another and
which has a ring-like magnetic core (4) disposed between the two main bounding surfaces (2, 3), which core has a front portion (5) and two lateral portions (6, 7) as well as a rear portion 8 and is formed by means of two core elements (9, 10) which extend parallel to the main bounding surfaces (2, 3) and which adjoin one another, which core elements are bounded by a front bounding surface (11) which extends perpendicularly to the main bounding surfaces (2, 3) and by a rear bounding surface (12) which extends perpendicularly to the main bounding surfaces (2, 3), and
which has a terminating element (21) arranged at the rear, which terminating element (21) is connected to the two core elements (9, 10) with the aid of a connecting layer (23) in the, area of the rear bounding surface (12), characterized in that in its rear portion (8) the magnetic core (4) has a thickness (D) which is constant throughout and which is defined by the distance (D) between the two main bounding surfaces (2, 3), and the terminating element (21) is connected to the two core elements (9, 10) via a connecting layer (23) having a high magnetic resistance.

2. A magnetic head (1) as claimed in claim 1, characterized in that the terminating element (21) consists of a non-magnetic polycrystalline ferrite.

3. A magnetic head (1) as claimed in claim 1, characterized in that the terminating element (21) consists of a ceramic material.

4. A magnetic head (1) as claimed in claim 1, characterized in that the terminating element (21) consists of glass.

5. A magnetic head (1) as claimed in claim 1, characterized in that the connecting layer (23) has a layer thickness in a range of approximately 10 μm.

6. A magnetic head (1) as claimed in claim 5, characterized in that the connecting layer (23) is formed by a layer of solder glass.
